(19) United States
(12) Patent Application Publication
(10) Pub. No.: US 2007/0184417 A1
(43) Pub. Date: Aug. 9, 2007

(54) System for coding alphabet pronunciation

(75) Inventor: Elizabeth Rosanne Litten, Queensland (AU)

Correspondence Address: YOUNG & THOMPSON, 745 SOUTH 23RD STREET, 2ND FLOOR, ARLINGTON, VA, 22202, US

(73) Assignee: Curtir Holding s Pty LTD, Queensland (AU)

(21) Appl. No.: 10/590,491

(22) PCT Filed: Feb. 25, 2005
(86) PCT No.: PCT/AU05/00268

§ 371 Date: Aug. 24, 2006

(30) Foreign Application Priority Data
Feb. 25, 2004 (AU) 2004900925

(51) Int. Cl. G09B 19/00

(52) U.S. Cl. 434/156

(57) ABSTRACT

A system for coding letters in an alphabet for word pronunciation includes a first code indicator for association with letters for indicating a lower case letter sound; a second code indicator for association with letters for indicating an upper case letter sound; a third code indicator for association with letters for indicating a silent letter sound; and a fourth code indicator for association with letters for indicating use of a sound varied from the upper or lower case sound, and having a variation sign for indicating that the associated letter or letters are for a sound varied from the lower case or upper case letter sound of the associated letter or letters, and a variation symbol for indicating a predetermined variation sound for associated letter or letters. The first and second code indicator may be associated with two or more letters for indicating blending of the sounds of associated letters.

### TECHNICAL FIELD OF THE INVENTION

THIS INVENTION relates to a system for coding letters in an alphabet for word pronunciation.

### BACKGROUND OF THE INVENTION

The English language is recognised as the main language for global business communications. It is therefore a popular aim to learn to read and speak English. However, it is difficult for most people, especially people whose first language is non-English, to learn to pronounce the English words. The reason is due to various discrepancies in sounds of letters used in the English words, and there are no set rules providing guidance to use the appropriate letter sounds in particular words.

Although English words are spelt with one or more of the twenty six letters of the English alphabets, the sounds of the letters within the words vary in what appears to be a random manner. The alphabet is usually taught by introducing students to the spelling sounds (hereinafter referred to as the capital letter case sounds) of the letters. The sounds of the letters (hereinafter referred to as the lower case letter sounds) in words are, however, generally different from the spelling sounds. Moreover, the sounds of the same letters in a word can vary depending on positions and context. Two or more letters are sometimes blended together in one sound which may also vary depending on positions and context. A considerable number of the English words are words originated from other languages (borrowed words). Some of these borrowed words are spelt in English but pronounced in the original foreign language sounds which are not found in the English sounds, while others of the borrowed words are spelt and pronounced in the English sounds. As the sounds of letters in words do not follow particular rules, students have difficulties recognising appropriate sounds to be used when reading and speaking English.

The applicant has observed that because of the random variations in letter sounds, “rote learning” remains the main process of teaching English. That is, students are taught by repeating sounds made by a teacher and by practising in private. This process is thus based on retention of the sounds in memory and repeated practice. Only students with good memory retention capacity and personal instructions would achieve a reasonable level of reading and speaking skills by learning through this “rote learning” process. As most people do not have a good memory and people who are learning English as a second language have little opportunity to communicate in English, the success rate of students acquiring reasonable level of reading and speaking English is quite low.

Although other Latin based languages such as French, German, Italian, Spanish and the like have somewhat less random variations in letter sounds, the “rote learning” process is also used for learners to memorise letter or syllable sounds within words.

### OBJECT OF THE INVENTION

An object of the invention is to substantial alleviate or to reduce to a certain level one or more of the prior art disadvantages.

### SUMMARY OF THE INVENTION

In one aspect therefore the present invention resides in a system for coding letters in an alphabet for word pronunciation. The system includes a first code indicator for association with one or more letters for indicating a lower case letter sound; a second code indicator for association with one or more letters for indicating an upper case letter sound; a third code indicator for association with one or more letters for indicating a silent letter sound; and a fourth code indicator for association with one or more letters for indicating use of a sound varied from the sound represented by the lower case or upper case letters, and having a variation sign for indicating that the associated letter or letters are for a sound varied from the lower case or upper case letter sound of the associated letter or letters, and a variation symbol for indicating a predetermined variation sound for the associated letter or letters.

The first code indicator may be associated with two or more letters for indicating blending of the sounds of the associated letters. The second code indicator may also be associated with two or more letters for indicating blending of the sounds of the associated letters.

The first code indicator can be positioned in between adjacent letters for indicating blending of the sounds of the adjacent letters. It is preferred that the first code indicator is a dot (.) sign positioned adjacent to the associated letter(s).

The second code indicator may be extendable for association with two or more letters for indicating blending of the sounds of the associated letters. It is also preferred that the second code indicator is a dash (-) sign positioned adjacent to the associated letter(s).

The third code indicator may also be extendable for associate on with two or more letters for indicating a silent sound of the associated letters. It is preferred that the third code indicator is a box (-) sign positioned containing the associated letter(s).

The fourth code indicator may be extendable for association with two or more letters for indicating use of a sound varying from the sounds represented by the lower case or upper case letters(s). The variation sign may be in the form of a tilda (˜) sign. The variation symbols for indicating variation sounds may include lower case letters for indicating corresponding lower case letter sounds, upper case letters for indicating corresponding upper case letter sounds, and numerals for indicating respective other sounds. In one form, the numerals include “1” for the “aow” sound, “2” for the “ar” sound, “3” for the “er” sound, “4” for the “OOe” sound, “5” for the “Or” sound, and “6” for the “ou” sound.

The lower case letter sounds may include the sounds for “a”, “b”, “c”, “ch”, “d”, “e”,“f”, “g”, “h”, “i”, “j”, “k”, “l”, “m”, “n”, “o”, “p”, “q”, “r”, “s”, “sh”, “t”, “th”, “u”, “v”, “w”, “x”, “y”, and“z”. The upper case letter sounds may include “A”, “B”, “C”, “D”, “E, “ef=F”, “G” “Ach=H”, “I”, “ja=J”, “kA=K”, “el=L”, “em=M”, “en=N”, “O”, “P”, “Cu =Q”, “ar=R”, “es=S”, “T”, “U”, “V”, “dbl U=W”, “ex=X”, “wl=Y”, AND “zed=Z”.

In another aspect therefore the present invention resides in an alphabet sound card including corresponding lower case letters and upper case letters arranged in groups, and variation sounds, indicated according to the above described the system. The card may also include pictorial means and/or words for guiding sounds to be used for the letter(s). For example, a pictorial of an ant and the word“ant” are associated with the lower case letter “a” for indicating that the letter has the sound like that in the word “ant”. Similarly, the mathematic representation of the numeral “eight” and the word therefor are associated with the upper case letter “A” for indicating that the letter has the sound like that in the numeral “eight”.

In a further aspect therefore the present invention resides in a booklet including words and letters in one or more of the words being arranged according to the above described the system.

In another further aspect therefore the present invention resides in a computer program including means for generating words formed with one or more letters, and means for associating the letter or letters of each of the words with a code indicator(s) according to the above described the system. The computer program may also include sound generating means arranged to generate an appropriate sound signal for the or each of the associated code indicator.

The sound generating means may have a number of audio messages and a message selector associated with each word for selecting one or more predetermined audio messages, and is arranged to generate an appropriate sound signal corresponding to the one or more predetermined audio messages when a message selector is selected.

In yet another further aspect therefore the present invention resides in an electronic device including a visual display unit, storage means, and processing means. The computer program as described is stored in the storage means and the processing means is arranged to generate words in respond to instructions from the computer program and to display the generated words on the visual display unit. The processing means may be arranged to cause an audio arrangement to produce sounds in accordance with the generated sound signals from the sound generating means.

The system of the present invention may be adapted for use with any other language that can be written in scripts.

### BRIEF DESCRIPTION OF THE DRAWINGS

In order that the system of the present invention can be readily understood and put in practically effect the description will now refer to the accompanying drawings which illustrate non-limiting embodiments of the present invention and wherein:-

FIG. 1 is a key phonetic chart showing the indicators for an embodiment of the system according to the present invention;

FIGS. 2A and 2B show an embodiment of the alphabet sound card according to the present invention;

FIGS. 3A and 3B show an embodiment of the representations of the vowels according to the system of the present invention;

FIGS. 4A and 4D show an embodiment of the representations of the consonants according to the system of the present invention;

FIG. 5 shows examples of the applications of the system of the present invention to numerals and units;

FIGS. 6 and 7 are respective instructions for teachers and students who use the system according to the present invention;

FIG. 8 shows selected pages of an embodiment of the booklet according to the present invention;

FIG. 9 shows a page generated by an embodiment of the computer program according to the present invention on a display monitor;

FIG. 10 shows the page shown in FIG. 9 with the audio message selectors revealed;

FIG. 11 shows another page with the audio message selectors revealed; and

FIG. 12 shows a further embodiment of the system according to the present invention for the French language.

### DETAILED DESCRIPTION OF THE DRAWINGS

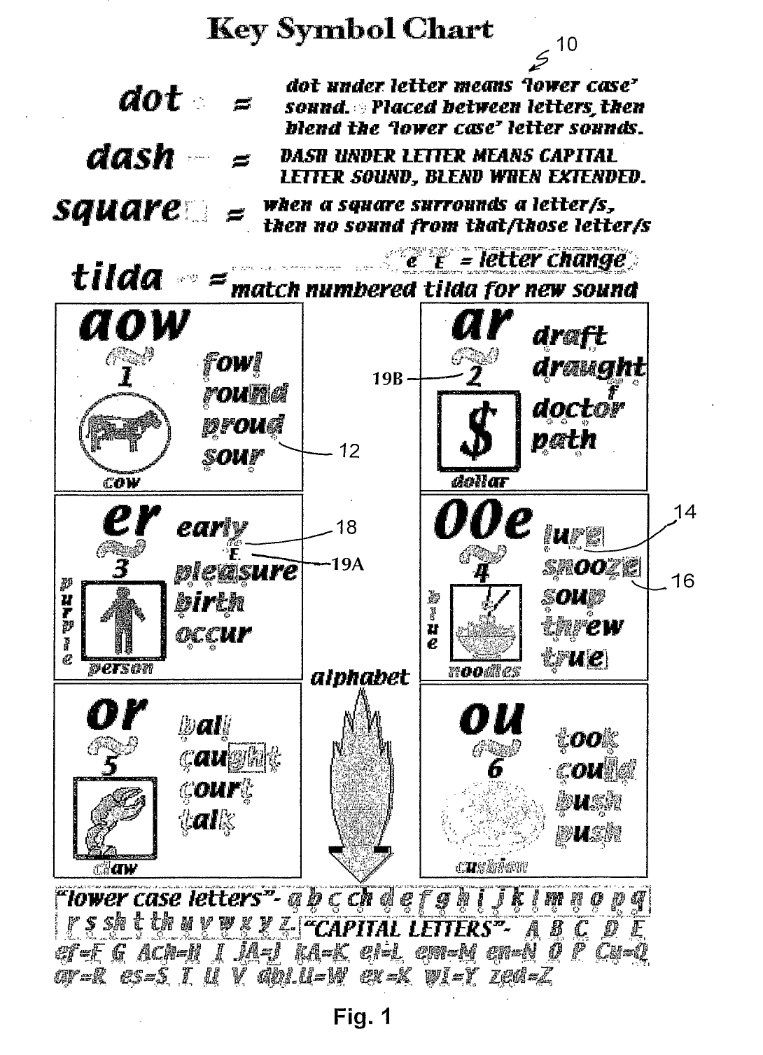

Referring to the drawings and initially to FIG. 1 there is shown a key phonetic chart 10 that is arranged to provide guidance on using the sound indicators 12 to 18 according to the system of the present invention. The first indicator 12 is for a lower case letter sound and is represented by a dot (.) sign. The second indicator 14 is for an upper case letter sound and is represented by a dash (-) sign. The third indicator 16 is for a silent letter and is represented by a box sign. The fourth indicator 18 is for a variation sound and is represented by a tilda (˜) sign.

As can be seen, the dot sign can be placed in between two lower case letters such as between the letters “t” and “h” in the word “birth” for indicating blending of the sounds of “t” and “h”. Similarly the box sign 16 can be extended to indicate two or more letters with a silent sound, such as the “gh” in the word caught. The tilda sign can also be extended to indicate blending of the sounds of two or more letters, such as “gh” in the word draught. The tilda signs are associated with a variation sign 19A comprising a lower case letter or an upper case letter and/or variation symbol 19B such as a numeral for a specific sound when there is no corresponding sound in the lower and upper case letters. In the chart as shown, there are six numerals for use with the tilda signs. The numerals can be extended for other sounds not found in the chart 10. The chart also shows the lower case letters and the upper case letters.

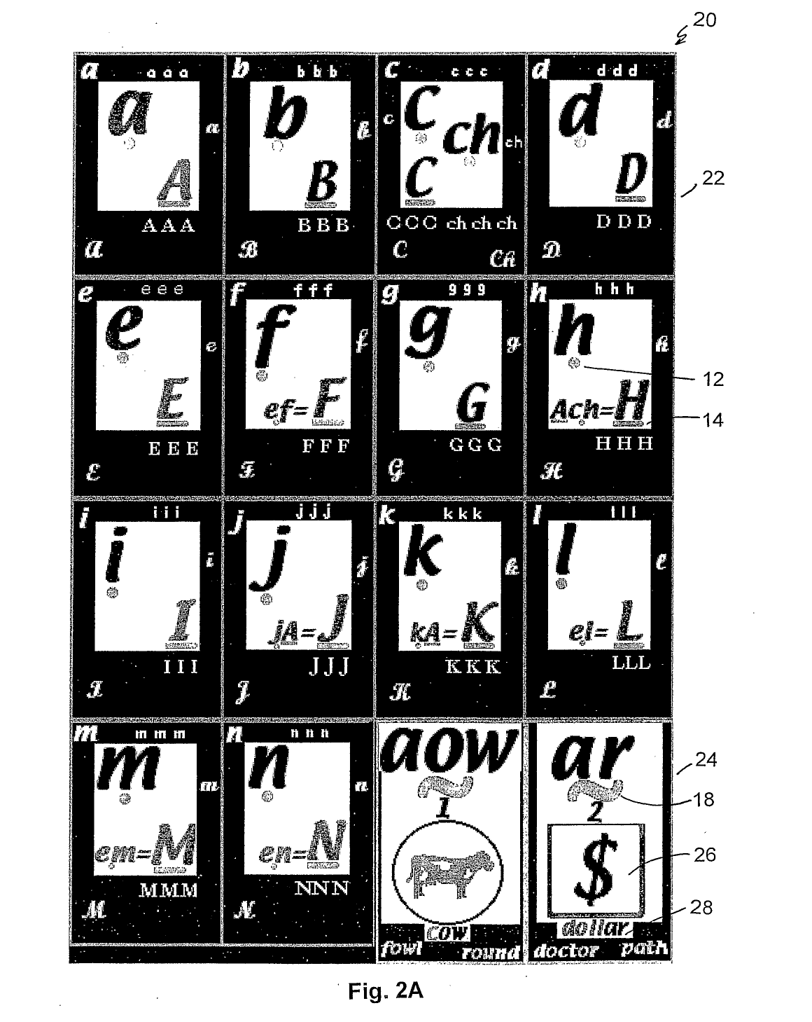

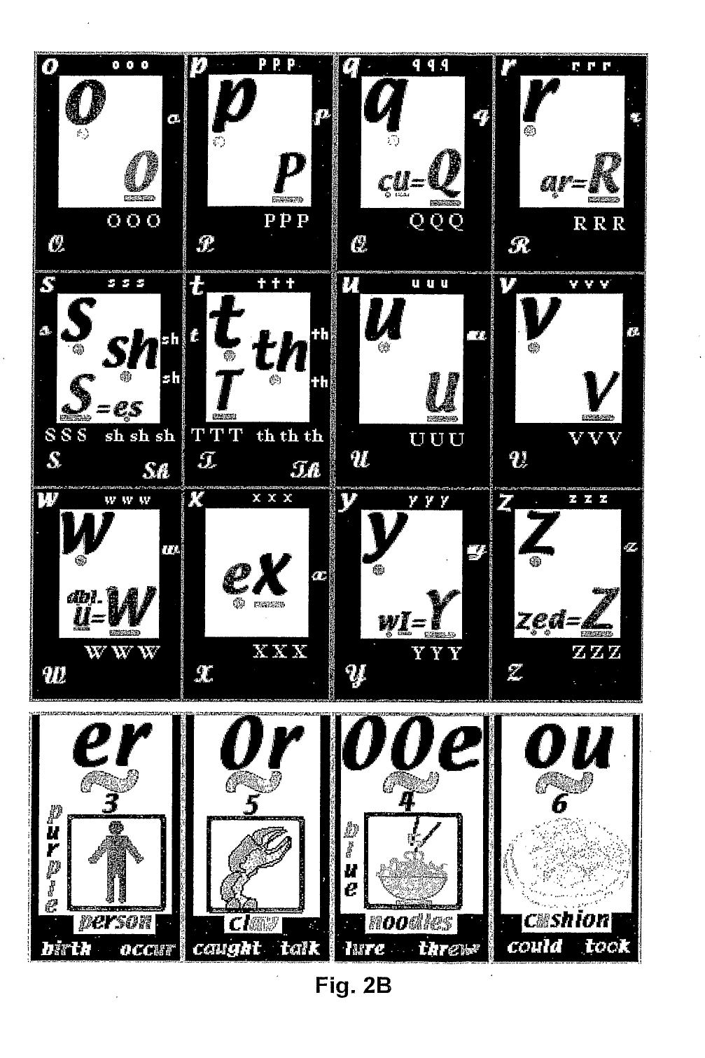

FIGS. 2A and 2B show an embodiment of the alphabet sound card 20 according to the present invention. The sound card 20 has corresponding lower and upper case letters grouped in boxes 22. The lower case letter in each of the boxes 22 is associated with the first indicator 12 and the second indicator 14. The boxes 22 also have the letters in different fonts for indicating that the letters can be represented in different fonts. Boxes 24 are provided for the indicators 18 the six variation sounds not amongst the sounds of the letters. The boxes 24 has relevant pictorials 26 and words 28 for guiding a user to use the appropriate sound.

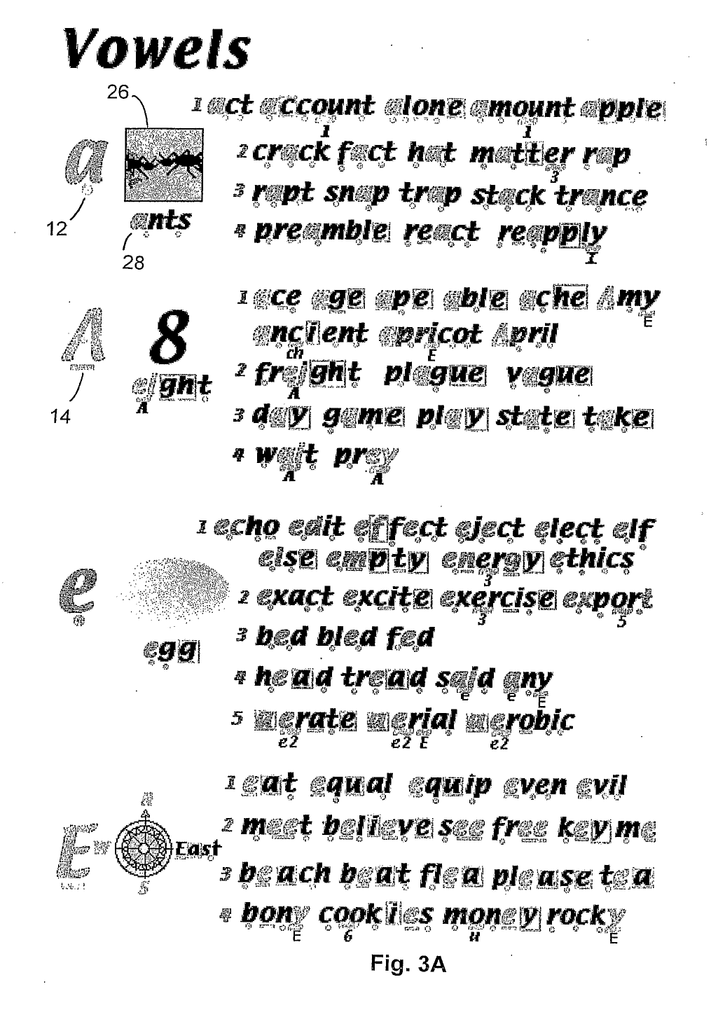

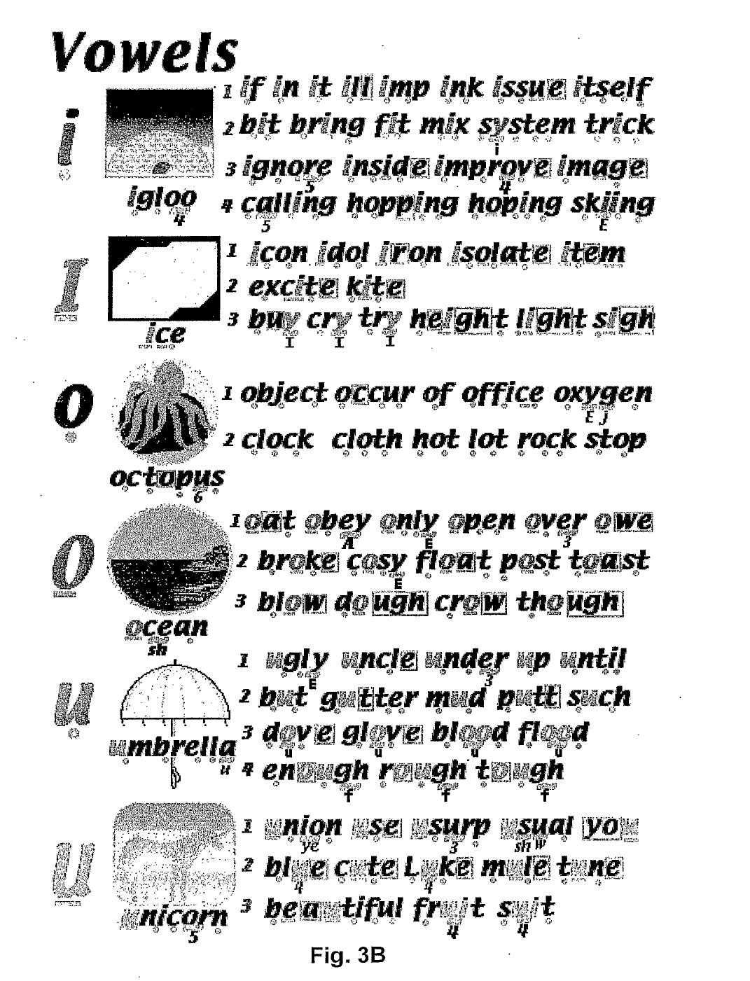

In FIGS. 3A and 3B the vowels as represented are associated with a dot 12 or a dash 14 depending on whether are lower case letter sound or upper case letter sound. The vowels are also associated with relevant pictorials 26 and words 28. The relevant pictorials and the words are for guiding a user ti use the appropriate sounds. A number of other words that incorporate the same sound for each of the vowels are also provided for students to practise the sound.

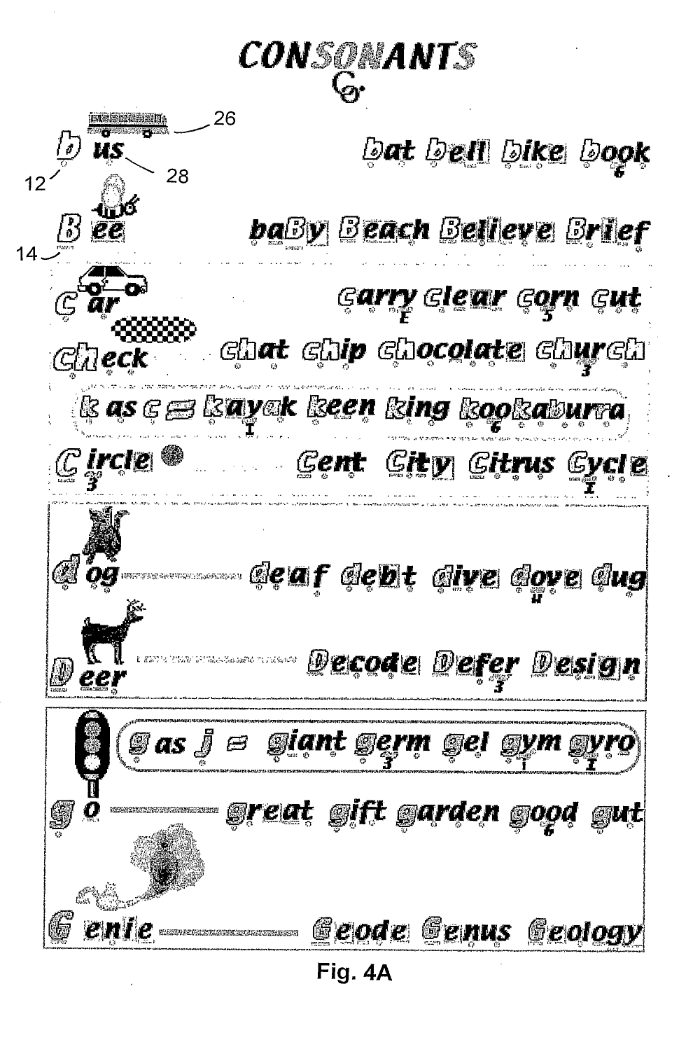

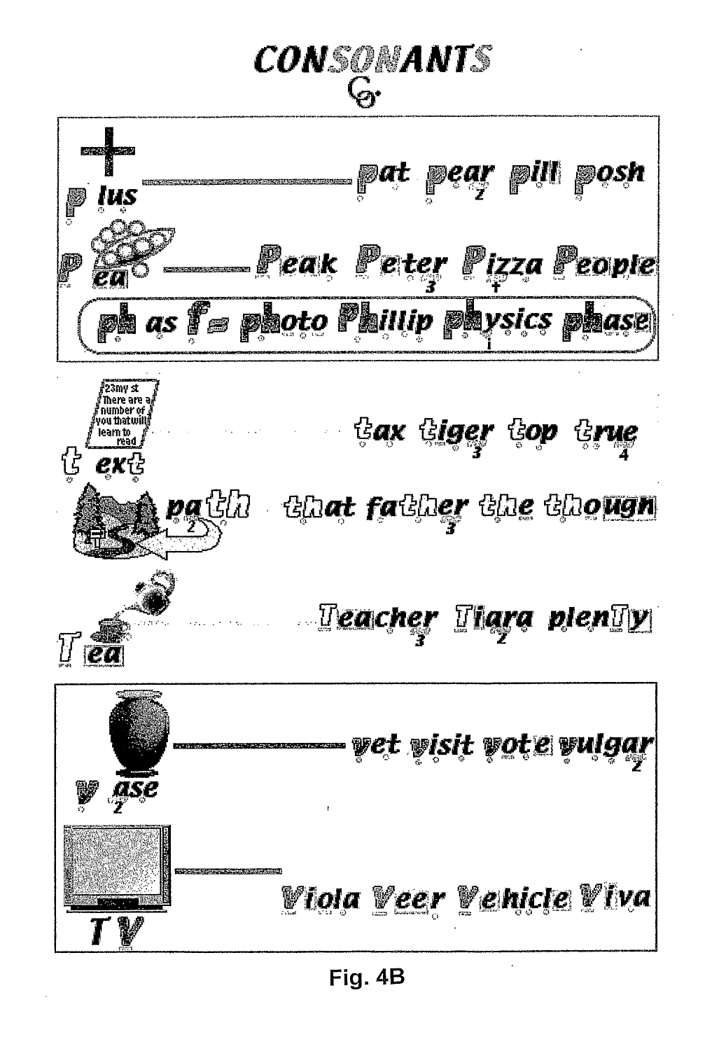

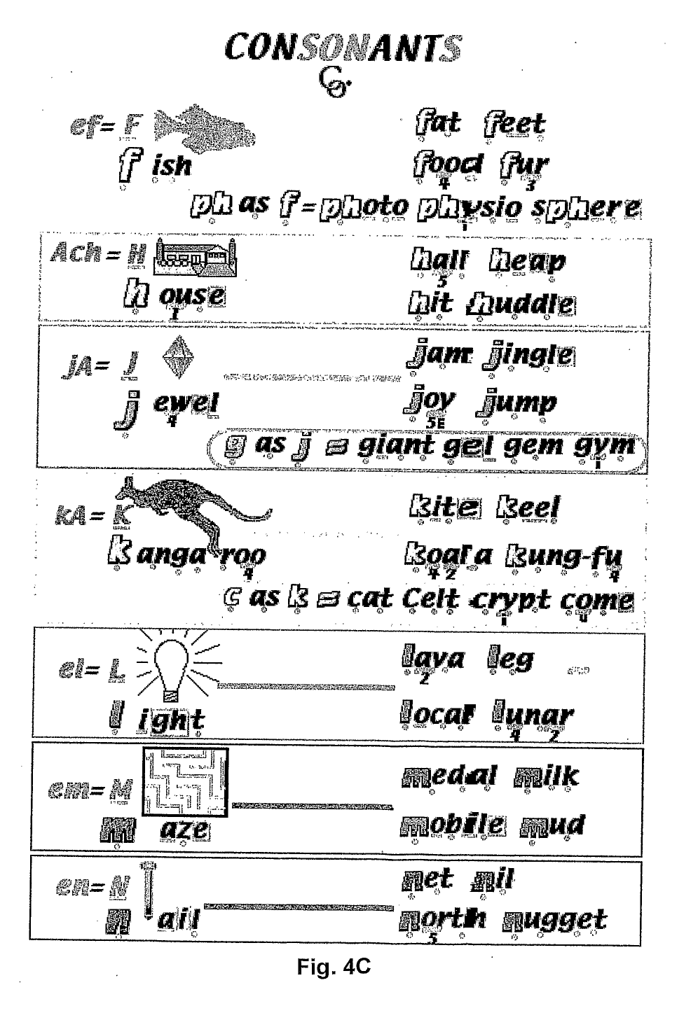

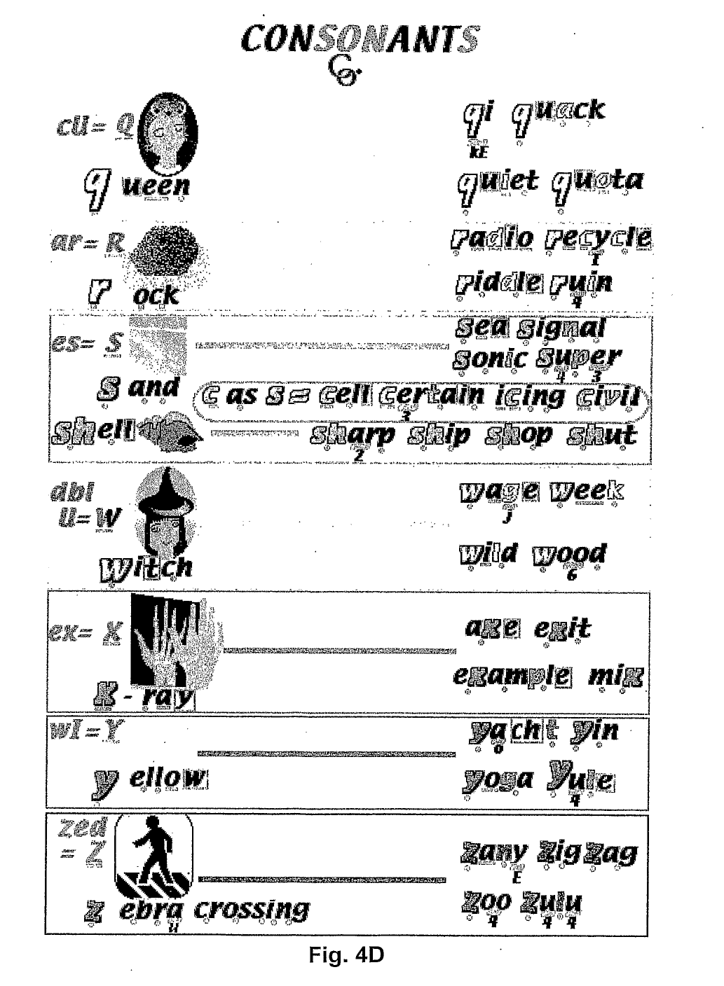

In FIGS. 4A and 4D the consonants are arranged in a manner as for the vowels shown in FIGS. 3A and 3B.

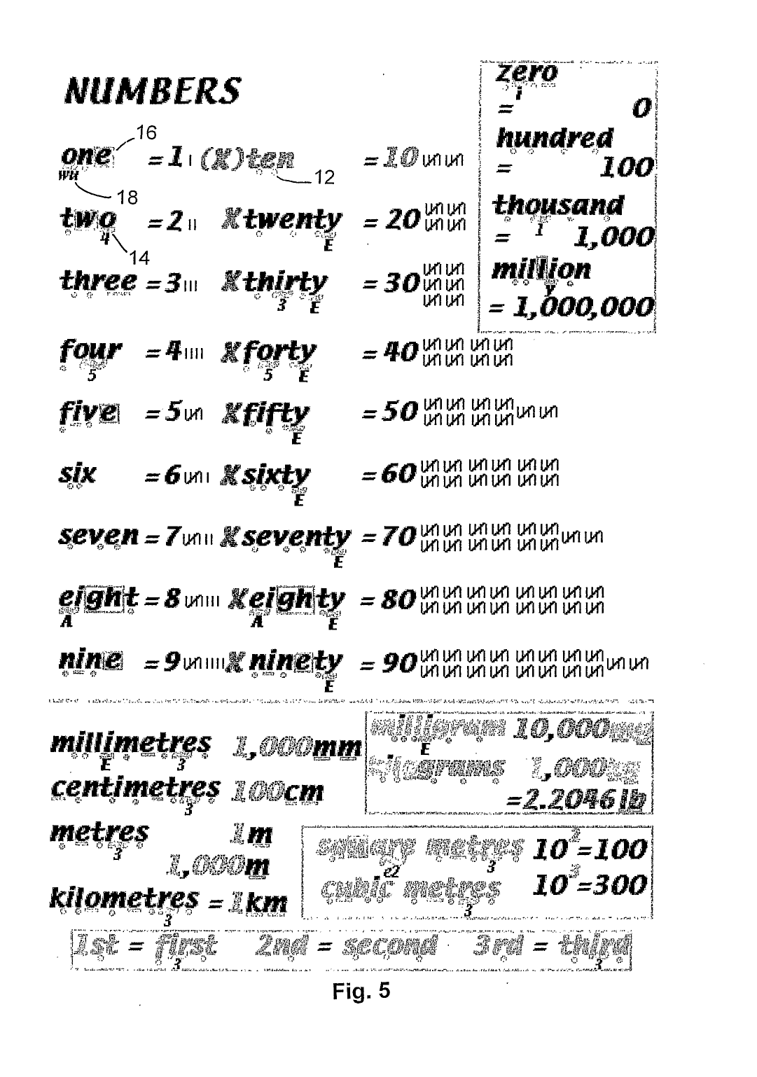

In FIG. 5 numerals and units of mathematics are represented in words and numeral representations. Each of the sounds for the number words are associated with any of the relevant indicators 12 to 18.

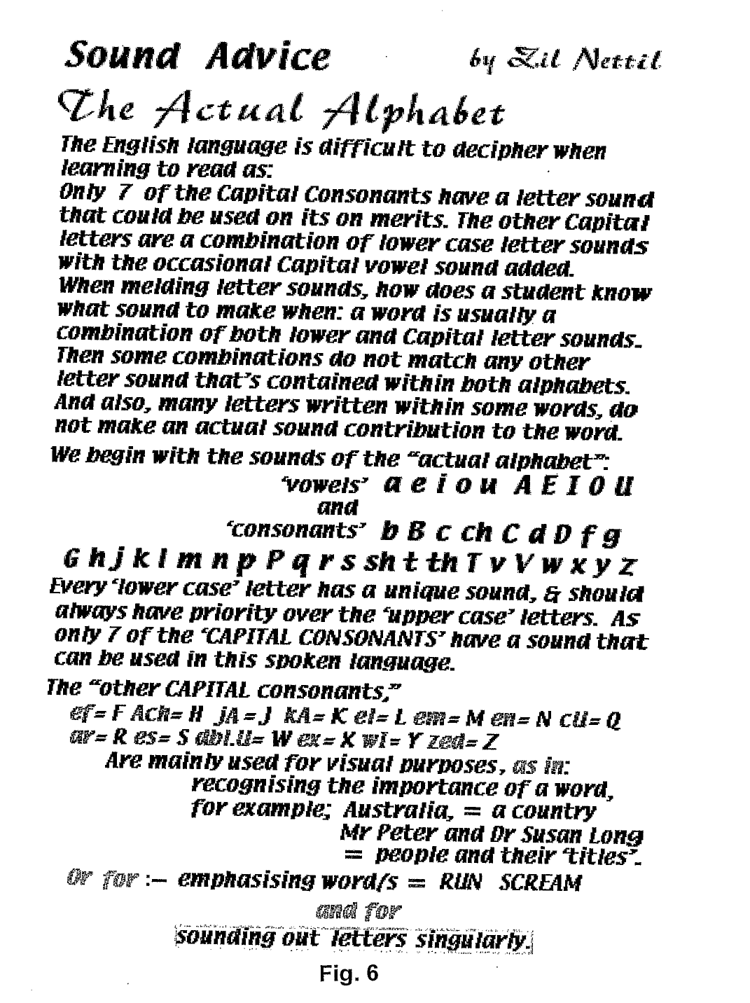

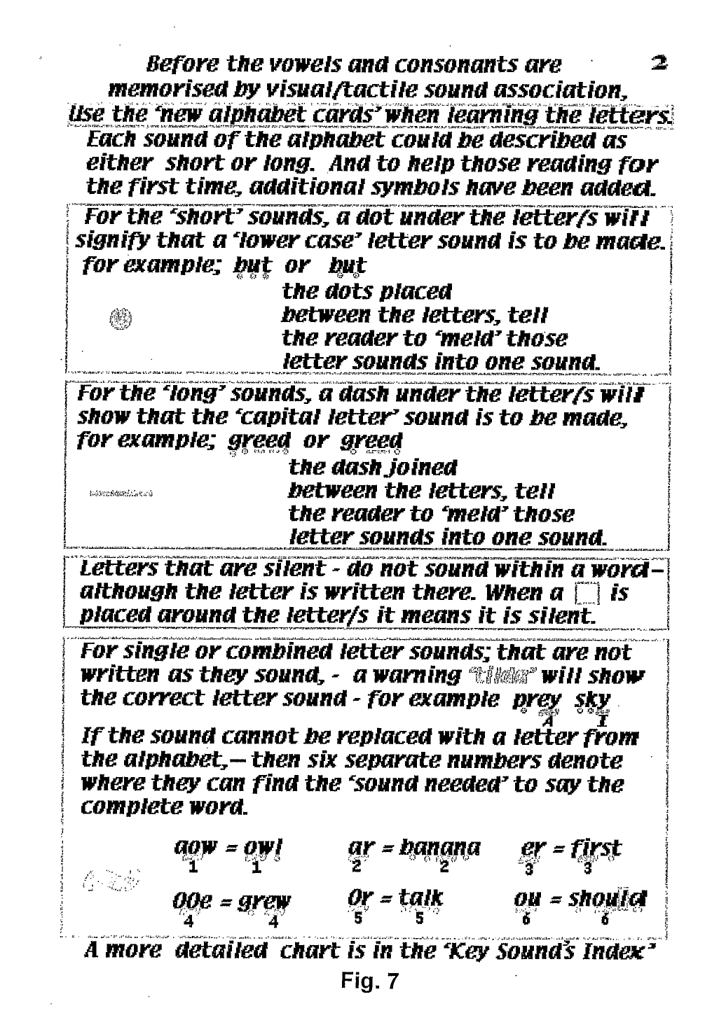

FIGS. 6 and 7 are respective examples of instruction sheets for a teacher to teach and a student to learn English sounds in accordance with the system 10 of the present invention.

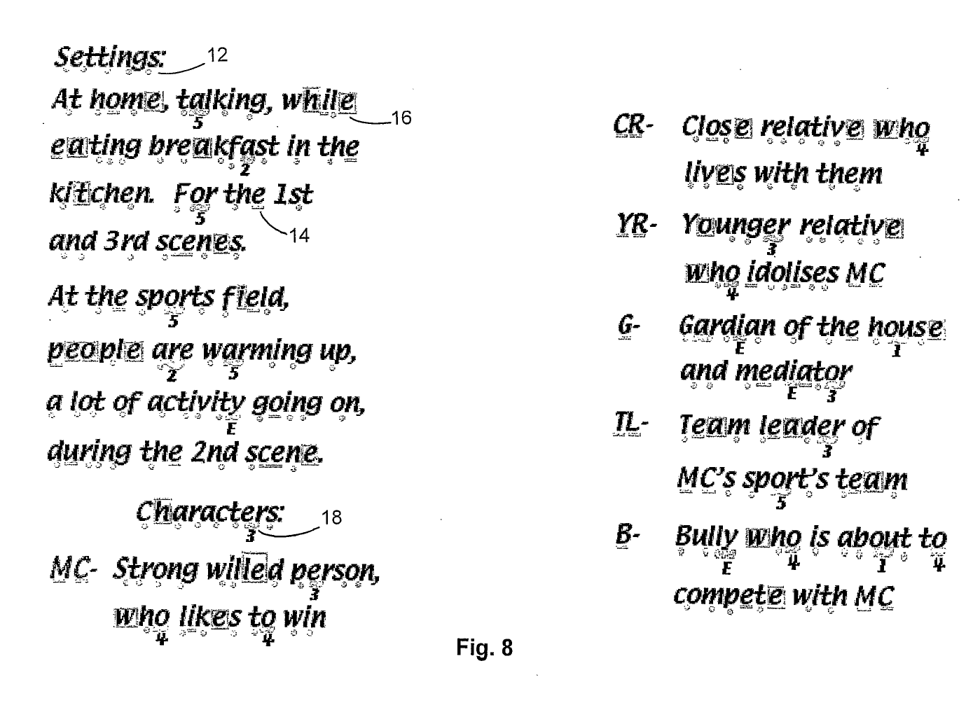

FIG. 8 shows pages 1 and 2 of the booklet entitled “Sports Day” Drama 2 created by the inventor. The words in the booklet are associated with the indicators 12 to 18 according to the system 10 of the present invention.

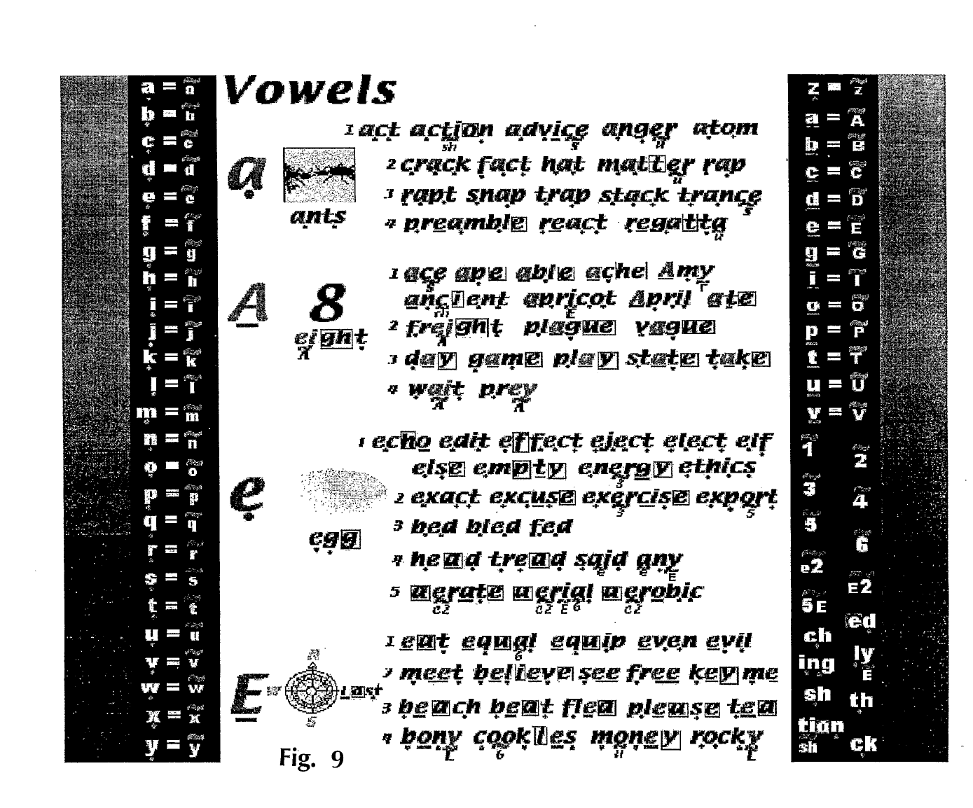

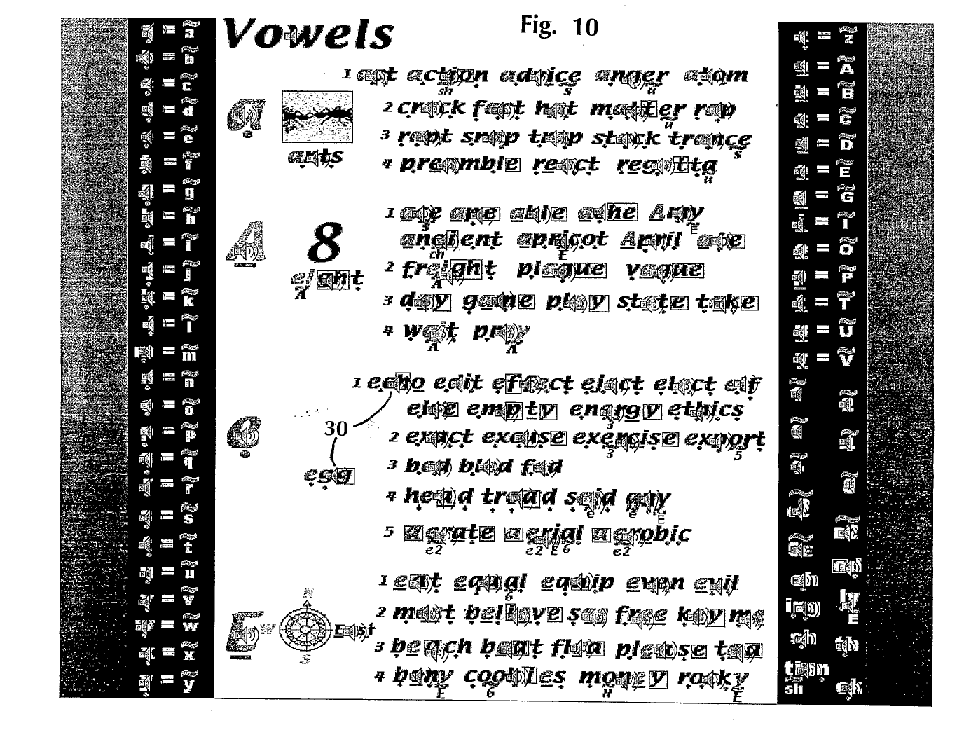

Referring to FIG. 9, there is shown a page generated by an embodiment of the computer program or the electronic device according to the present invention. The program/device has a library of audio messages stored on a recordable medium such as a compact disk or a hard disk and on the displayed page a hidden audio message selector 30 shown as a loud speaker symbol (see FIG. 10) associated with each word or letter. A user may select any of the selectors for the program/device to case the program/device to retrieve the appropriate stored message to generate an audio signal corresponding to the sound(s) for the pronunciation of the selected word(s) or letter.

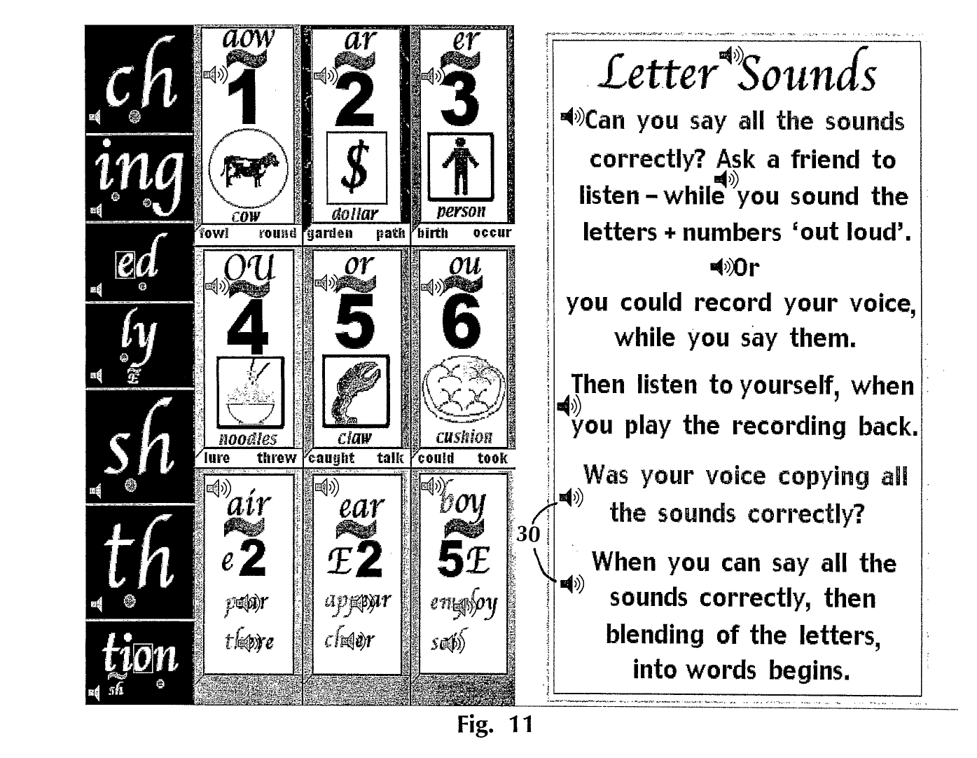

FIG. 11 shows a page on a display monitor where some of the message selectors 30 are for selecting messages corresponding to pronunciations of words in a sentence or phrase.

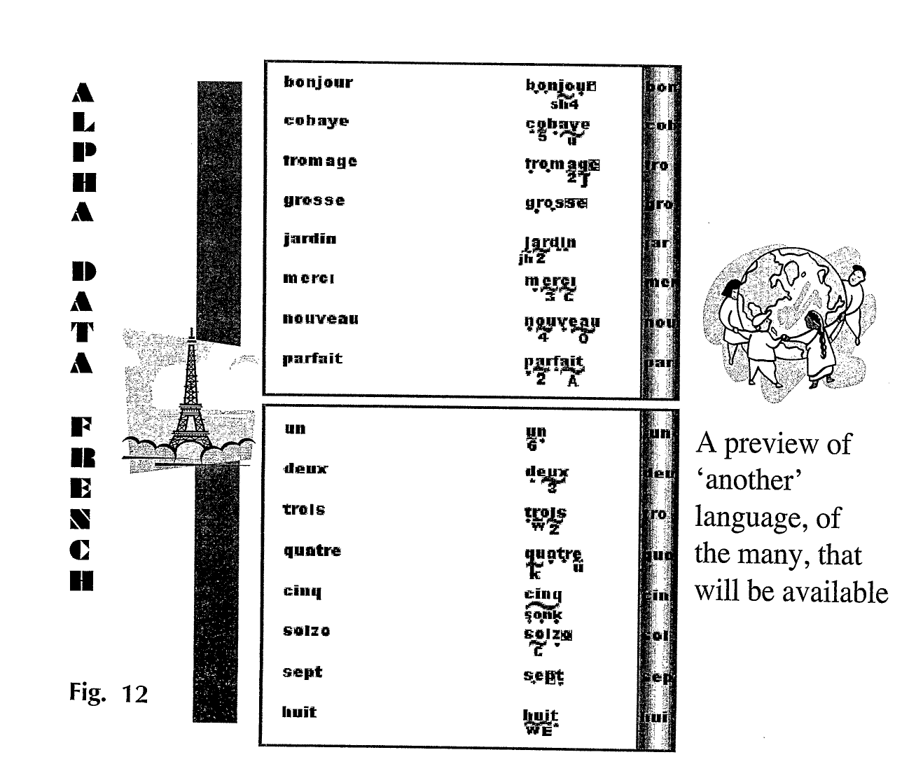

FIG. 12 shows an embodiment of the program/device according to the present as applied to some French words on a display monitor.

Whilst the above has been given by way of illustrative examples of the present invention, many variations and modifications thereto will be apparent to those skilled in the art without departing from the broad ambit and scope of the invention as herein set forth in the claims.

1-22. (canceled)

23. A system of coding letters in an alphabet for word pronunciation comprising:
(a) a first code indicator for association in position with one letter or one group of letters in a word for indicating a lower case letter sound of the first indicator associated letter or group of letter;
(b) a second code indicator for association in position with one letter or one group of letters in a word for indicating an upper case letter sound of the second indicator associated letter or group of letter;
(c) a third code indicator for association in position with one letter or one group of letters in a word for indicating a silent sound attributed to the third indicator associated letter or group of letter; and
(d) a fourth code indicator for association in position with one letter or one group of letters in a word for indicating use of a sound varied from the lower case or upper case letter sound of the fourth indicator associated letter or group of letters, and having a variation sign for indicating that the associated letter or group of letters being a sound varied from the lower case or upper case letter sound of the fourth indicator associated letter or group of letters, and a variation symbol for indicating a specific variation sound of a set of predetermined variation sounds for the fourth code associated letter or group of letters; and
(e) wherein said first, second and third codes indicators being non alpha signs.

24. The system according to claim 23 wherein the first code indicator being associated with a group of two or more letters for indicating blending of the sounds of the first code associated group of letters.

25. The system according to claim 24 wherein the first code indicator being positionable in between adjacent letters in the group of letters for indicating blending of the sounds of the adjacent letters.

26. The system according to claim 23 wherein the first code indicator is a dot (.) sign positioned adjacent to the first code associated letter or group of letters.

27. The system according to claim 23 wherein the second code indicator being associated with a group of two or more letters for indicating blending of the sounds of the second code associated group of letters.

28. The system according to claim 27 wherein the second code indicator being selectively extendable for association with the group of letters for indicating blending of the sounds of the second code associated letters.

29. The system according to claim 27 wherein the second code indicator is a dash (-) sign positioned adjacent to the second code associated letter or group of letters.

30. The system according to claim 23 wherein the third code indicator being selectively extendable for association with a group of two or more letters for indicating a silent sound of the third code associated group of letters.

31. The system according to claim 30 wherein the third code indicator is a box (□) sign positioned to contain the third code associated letter or group of letters therein.

32. The system according to claim 23 wherein the fourth code indicator being selectively extendable for association with a group of two or more letters for indicating use of a sound varying from the sounds of the lower case or upper case letters.

33. The system according to claim 23 wherein the variation sign being in the form of a tilda (˜) sign.

34. The system according to claim 23 wherein the variation symbols for indicating variation sounds including lower case letters for indicating corresponding lower case letter sounds, upper case letters for indicating corresponding upper case letter sounds, and numerals for indicating respective other specific variation sounds of the set of predetermined variation sounds.

35. The system according to claim 34 wherein the numerals include “1” for the “aow” sound, “2” for the “ar” sound, “3” for the “er” sound, “4” for the “OOe” sound, “5” for the “Or” sound, and “6” for the “ou” sound.

36. The system according to claim 23 wherein the lower case letter sounds include the sounds for “a”, “b”, “c”, “ch”, “d”, “e, “f”, “g” “h”, “i”, “j”, “k”, “l”, “m”, “n”, “o”, “p”, “q”, “r”, “s”, “sh”, “t”, “th”, “u”, “v”, “w”, “x”, “y”, and “z” and the upper case letter sounds include “A”, “B”, “C”, “D”, “E, “ef=F”, “G” “Ach=H”, “I”, “ja=J”, “kA=K”, “el=L”, “em=M”, “en=N”, “O”, “P”, “Cu=Q”, “ar=R”, “es=S”, “T”, “U”, “V”, “dbl U=W”, “ex=X”, “wI=Y”, AND “zed=Z”.

37. An alphabet sound card including corresponding lower case letters and upper case letters arranged in groups, and variation sounds, and associated with the code indicators arranged according to the system as claimed in claim 23.

38. The card according to claim 37 further including pictorial means and/or words associated with a letter or letters for guiding use of appropriate sound(s) for the letter(s).

39. A booklet including words and letters in one or more of the words being arranged according to the system as claimed in claim 23.

40. A computer program including means for generating. words formed with one or more letters, and means for associating the letter or letters of each of the words with a code indicator(s) and wherein the code indicators being arranged according to the system as claimed in claim 23.

41. The computer program according to claim 40 wherein further including sound generating means arranged to generate an appropriate sound signal for the or each of the associated code indicator.

42. The computer program according to claim 40 wherein the sound generating means having a number of audio messages and a message selector associated with each letter or word or a passage for selecting one or more predetermined audio messages, and being arranged to generate an appropriate sound signal corresponding to the one or more predetermined audio messages when a message selector is selected.

43. An electronic device including a visual display unit, storage means, processing means and a computer program as claimed in claim 40, wherein the computer program being stored in the storage means and the processing means is arranged to generate words in respond to instructions from the computer program and to display the generated words on the visual display unit.

44. The electronic device according to claim 43 wherein the processing means being arranged to cause an audio arrangement to produce sounds in according with the generated sound signals from the sound generating means.
